(19) United States
(12) Patent Application Publication
(10) Pub. No.: US 2015/0083959 A1
(43) Pub. Date: Mar. 26, 2015

(54) MAGNETIC MATERIAL AND DEVICE

(71) Applicant: Kabushiki Kaisha Toshiba, Minato-ku (JP)

(72) Inventors: Tomoko EGUCHI, Chuo (JP); Seiichi SUENAGA, Yokohama (JP); Koichi HARADA, Bunkyo (JP); Tomohiro SUETSUNA, Kawasaki (JP); Toshihide TAKAHASHI, Yokohama (JP)

(73) Assignee: Kabushiki Kaisha Toshiba, Minato-ku (JP)

(21) Appl. No.: 14/480,744

(22) Filed: Sep. 9, 2014

(30) Foreign Application Priority Data
Sep. 20, 2013 (JP) 2013-194771

(51) Int. Cl. H01F 1/01

(52) U.S. Cl. CPC H01F 1/01
USPC 252/62.54

(57) ABSTRACT

A magnetic material of an embodiment includes a plurality of magnetic metal particles, a plurality of columnar oxide particles, and a matrix phase. Each of the plurality of the magnetic metal particles includes at least one element selected from a first group consisting of Fe, Co, and Ni. Each of the plurality of the columnar oxide particles includes at least one oxide selected from a second group consisting of Al₂O₃, SiO₂, and TiO₂ and is in contact with the magnetic metal particle. The matrix phase has a higher electrical resistance than each of the plurality of the magnetic metal particles. The matrix phase surrounds the plurality of magnetic metal particles and the plurality of columnar oxide particles. In the magnetic material, 5 nm≦l≦L and 0.002≦L/R≦0.4 hold, where R represents a particle size of the magnetic metal particle, L represents a length of the columnar oxide particle, and l represents a breadth of the columnar oxide particle.

### CROSS-REFERENCE TO RELATED APPLICATION

This application is based upon and claims the benefit of priority from Japanese Patent Application No. 2013-194771, filed on Sep. 20, 2013, the entire contents of which are incorporated herein by reference.

### FIELD

Embodiments described herein relate generally to a magnetic material and a device.

### BACKGROUND

In order to mount power semiconductors on various kinds of apparatuses, development of a power inductor or development of a magnetic material having high magnetic permeability and low magnetic loss in MHz bands is essentially important. In addition, high saturation magnetization is required to deal with large currents. If saturation magnetization is high, application of a high magnetic field does not easily cause magnetic saturation, and decreases in the effective inductance value can be restrained. As a result, the DC superimposition characteristics of devices are improved, and system efficiency becomes higher.

A radiowave absorber absorbs noise generated from an electronic apparatus by using high magnetic loss, and reduce errors in the electronic apparatus such as wrong operations. Electronic apparatuses are used in various frequency bands, and high magnetic loss is required in predetermined frequency bands. In general, a magnetic material exhibits high magnetic loss at around the ferromagnetic resonance frequency. The ferromagnetic resonance frequency of a magnetic material that has low magnetic loss in MHz bands normally is in GHz bands. Accordingly, a magnetic material for MHz-band power inductor can be applied in a radiowave absorber which is used in GHz bands, for example.

If a magnetic material that has high magnetic permeability and low magnetic loss in MHz bands as described above is developed, the magnetic material can be used in a device such as a power inductor, an antenna device, or a radiowave absorber in the high-frequency band of MHz and higher.

### BRIEF DESCRIPTION OF THE DRAWINGS

FIG. 1 is a schematic view of a magnetic material of a first embodiment;

FIGS. 2A through 2C are schematic views of columnar oxide particles of the first embodiment;

FIG. 3 is a schematic view of a magnetic material of a second embodiment;

FIGS. 4A and 4B are conceptual diagrams of devices of a third embodiment;

FIGS. 5A and 5B are conceptual diagrams of devices of the third embodiment; and

FIG. 6 is a conceptual diagram of a device of the third embodiment.

### DETAILED DESCRIPTION

A magnetic material of an embodiment includes: a plurality of magnetic metal particles, each of the plurality of the magnetic metal particles including at least one element selected from a first group consisting of Fe, Co, and Ni; a plurality of columnar oxide particles, each of the plurality of the columnar oxide particles including at least one oxide selected from a second group consisting of Al₂O₃, SiO₂, and TiO₂, each of the plurality of the columnar oxide particles being in contact with the magnetic metal particle; and a matrix phase having a higher electrical resistance than each of the plurality of the magnetic metal particles, the matrix phase surrounding the plurality of magnetic metal particles and the plurality of columnar oxide particles, wherein 5 nm≦l≦L, and 0.002≦L/R≦0.4, where R represents a particle size of the magnetic metal particle, L represents a length of the columnar oxide particle, and l represents a breadth of the columnar oxide particle.

The following is a description of embodiments, with reference to the accompanying drawings.

The inventors have discovered the following: in a magnetic material, columnar oxide particles are made to adhere to the surfaces of magnetic metal particles, so that increases in intraparticle eddy-current loss due to aggregation of the magnetic metal particles can be effectively restrained with a small amount of oxide particles. As a result, a magnetic material that has a high filling rate of the magnetic metal particles and a high resistance, and excels in increasing saturation magnetization, increasing magnetic permeability, and reducing magnetic loss in high-frequency bands can be easily manufactured. The embodiments described below have been completed based on the above findings made by the inventors.

### First Embodiment

A magnetic material of this embodiment includes: a plurality of magnetic metal particles, each of the plurality of the magnetic metal particles including at least one element selected from a first group consisting of Fe, Co, and Ni; a plurality of columnar oxide particles, each of the plurality of the columnar oxide particles including at least one oxide selected from a second group consisting of Al₂O₃, SiO₂, and TiO₂, each of the plurality of the columnar oxide particles being in contact with the magnetic metal particle; and a matrix phase having a higher electrical resistance than each of the plurality of the magnetic metal particles, the matrix phase surrounding the plurality of magnetic metal particles and the plurality of columnar oxide particles, wherein 5 nm≦l≦L, and 0.002≦L/R≦0.4, where R represents a particle size of the magnetic metal particle, L represents a length of the columnar oxide particle, and l represents a breadth of the columnar oxide particle.

Having the above described structure, the magnetic material of this embodiment realizes high saturation magnetization, high magnetic permeability, and low magnetic loss particularly in the MHz bands of 1 MHz and higher.

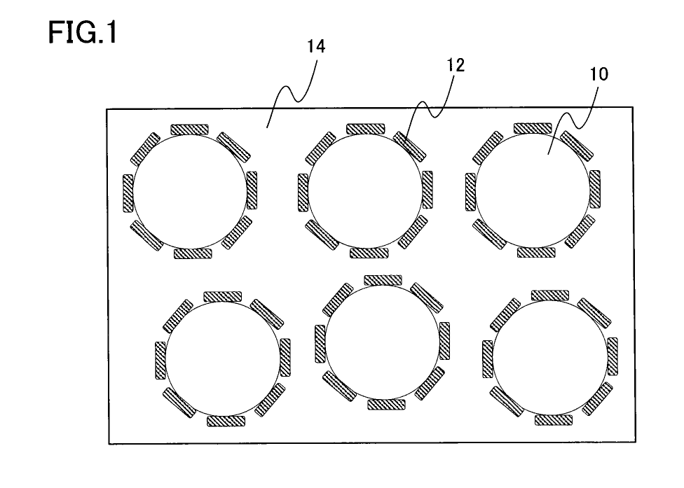

FIG. 1 is a schematic cross-sectional view of the magnetic material of this embodiment. The magnetic material of this embodiment includes magnetic metal particles 10, columnar oxide particles 12, and a matrix phase 14.

Each of the magnetic metal particles 10 includes at least one element selected from the group consisting of Fe, Co, and Ni. The magnetic metal particles 10 may be an elementary metal such as Fe, Co, or Ni. The magnetic metal particles 10 may be an alloy such as an Fe-based alloy, a Co-based alloy, an FeCo-based alloy, or an FeNi-based alloy. Examples of Fe-based alloys include an FeNi alloy, an FeMn alloy, and an FeCu alloy. Examples of Co-based alloys include a CoNi alloy, a CoMn alloy, and a CoCu alloy. Examples of FeCo-based alloys include an FeCoNi alloy, an FeCoMn alloy, and an FeCoCu alloy. In some cases, oxide films 18 covering the respective magnetic metal particles 10 may be formed on the magnetic metal particles 10.

The magnetic metal particles 10 may be spherical particles or flattened particles. Where the magnetic metal particles 10 are flattened particles, and the magnetizations of the magnetic metal particles 10 are oriented, the magnetic permeability is higher than that of spherical particles.

The particle size of the magnetic metal particles 10 is represented by R. The particle size R is observed with a scanning electron microscope (SEM), for example. The magnification of the SEM is 2,000 to 10,000, and an image of a cross-section of the magnetic material is observed at such a minimum magnification that exactly fifty magnetic metal particles 10 are included in one image. The five particles that are the largest in particle size are selected from the primary particles of all the magnetic metal particles 10 observed in one image, and the respective five particles are surrounded with the smallest possible circles. Here, the diameter of the smallest circle is regarded as the particle size of each magnetic metal particle 10. The mean value among the five particle sizes is represented by R₁. Images of cross-sections of the magnetic material are observed with five different fields of view, and R₁, R₂, R₃, R₄, and R₅ are measured. Further, the mean value among R₁ through R₅ is defined as R.

Each of the columnar oxide particles 12 includes Al₂O₃, SiO₂, or TiO₂. Each of the columnar oxide particles 12 is in contact with the surfaces of the magnetic metal particles 10, and are integrated with the magnetic metal particles 10. The columnar oxide particles 12 preferably include none of the elements included in the first group consisting of Fe, Co, and Ni, at least one of which is included in the magnetic metal particles 10.

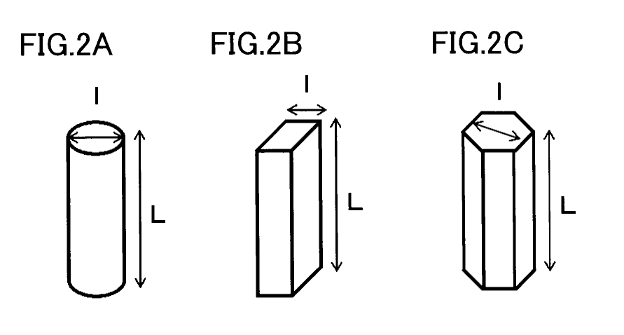

Each of the columnar oxide particles 12 may be in the form of a prism or a cylinder. FIGS. 2A through 2C schematically show examples of the columnar oxide particles 12. FIG. 2A shows a cylinder, FIG. 2B shows a rectangular prism, and FIG. 2C shows a hexagonal prism. However, the shape is not limited to them. The largest length of each columnar oxide particle 12 is the length L, and the shortest length of a side surface projected parallel to the length L is the breadth l. The length L and the breadth l are observed with a transmission electron microscope (TEM), for example. The magnification of the SEM or the TEM is 20,000 to 200,000, and an image of a cross-section of the magnetic material is observed at such a minimum magnification that exactly 10 columnar oxide particles 12 in contact with magnetic metal particles 10 are included in one image. The three particles that have the largest side lengths are selected from the primary particles of all the columnar oxide particles 12 observed in one image, and the mean value among the largest side lengths is set as L₁. Likewise, the three particles that have the smallest side lengths are selected, and the mean value among the smallest side lengths is set as l₁. Images of cross-sections of the magnetic material are observed with five different fields of view, and L₁, L₂, L₃, L₄, L₅, l₁, l₂, l₃, l₄, and l₅ are measured. The mean value among L₁ through L₅ is defined as the length L, and the mean value among l₁ through l₅ is defined as the breadth l.

In the magnetic material of this embodiment, the columnar oxide particles 12 are made to adhere to the surfaces of the magnetic metal particles 10, so that increases in intraparticle eddy-current loss due to aggregation of the magnetic metal particles 10 can be effectively restrained with a small amount of oxide particles. As a result, a magnetic material that has a high filling rate of the magnetic metal particles 10 and a high resistance, and excels in increasing saturation magnetization, increasing magnetic permeability, and reducing magnetic loss in high-frequency bands can be realized.

To effectively realize high magnetic permeability in high-frequency bands such as MHz bands and GHz bands, the magnetic metal particles 10 should be made smaller in particle size than magnetic metal particles 10 with a particle size of approximately 50 μm or larger that are used in magnetic materials for kHz bands so that ferromagnetic resonance frequency is higher. Where the magnetic metal particles 10 are smaller in particle size, however, aggregation of the magnetic metal particles 10 tends to progress quickly, and the eddy current appearing in the magnetic metal particles 10 increases, resulting in an increase in eddy-current loss.

In view of this, the columnar oxide particles 12 are made to adhere to the surfaces of the magnetic metal particles 10 as shown in FIG. 1. In this manner, contact between the magnetic metal particles 10 is prevented, and aggregation of the magnetic metal particles 10 can be restrained. An example case is now described, that is, spherical oxide particles having the same particle size as the breadth of the columnar oxide particles 12 are used in place of the columnar oxide particles 12. When the same number of spherical oxide particles as the number of the columnar oxide particles 12 in FIG. 1 is made to adhere to the surfaces of the magnetic metal particles 10, the areas covered with the oxide particles becomes smaller on the surfaces of the magnetic metal particles 10. As a result, the magnetic metal particles 10 are easily brought into contact with one another, and aggregation progresses quickly. Next, an example case is described, that is, spherical oxide particles having the same particle size as the length of the columnar oxide particles 12 are used in place of the columnar oxide particles 12. When the same number of spherical oxide particles as the number of the columnar oxide particles 12 in FIG. 1 is made to adhere to the surfaces of the magnetic metal particles 10, the thickness of the oxide particle layer becomes greater, and the filling rate of the magnetic metal particles 10 cannot be easily increased. As a result, it becomes difficult to achieve high saturation magnetization and high magnetic permeability.

As described above, with the use of the columnar oxide particles 12, contact between the magnetic metal particles 10 or aggregation can be restrained with a small amount of oxide particles. A high filling rate of the magnetic metal particles 10 and a high resistance of the magnetic material are achieved at the same time, and high saturation magnetization and high magnetic permeability can be obtained. With the use of the columnar oxide particles 12, the effect to restrain aggregation is achieved with a small number of oxide particles, and uniform oxide particle dispersion on the surfaces of the magnetic metal particles 10 can be easily performed. Furthermore, as the contact area between one magnetic metal particle 10 and one oxide particle is large, the oxide particles are not easily removed in the manufacturing process.

The matrix phase 14 is disposed around the magnetic metal particles 10 and the columnar oxide particles 12, i.e., the matrix phase 14 surrounds the magnetic metal particles and the columnar oxide particles, and the electrical resistance thereof is higher than each of the magnetic metal particles 10. The matrix phase 14 is used to reduce the eddy-current loss due to the eddy-current flowing in the entire material. Examples of materials that can be used as the matrix phase 14 include the air, glass, organic resins, oxides, nitrides, and carbides. Examples of the organic resins include epoxy resins, imide resins, vinyl resins, silicone resins, and the like. Examples of the epoxy resins include bisphenol A epoxy resin and biphenyl epoxy resin. Examples of the imide resins include polyamide-imide resin and polyamic acid polyimide resin. Examples of the vinyl resins include polyvinyl alcohol resin and polyvinyl butyral resin. Examples of the silicone resins include methyl silicone resin and alkyd-modified silicone resin. The resistance value of the material of the matrix phase 14 is preferably 1 mΩ·cm or higher, for example.

It is possible to determine whether or not the electrical resistance of the matrix phase 14 is higher than the electrical resistance of the magnetic metal particles 10, by calculating the electrical resistance from the current and voltage values between terminals according to a four-terminal or two-terminal electrical resistance measuring method. For example, while an electron image of a sample formed by mixing the magnetic metal particles 10 and the matrix phase 14 is observed with a scanning electron microscope, terminals (probes) are brought into contact with the magnetic metal particles 10 and the matrix phase 14, to measure the electrical resistances. By this method, the electrical resistance value of the material of the matrix phase 14 can also be evaluated.

The relational expression of the breadth l and the length L of the columnar oxide particles 12 is 5 nm≦l≦L. If the breadth l is smaller than 5 nm, manufacturing the oxide particles becomes difficult, and therefore, such a small breadth is not preferable. Since the length L and the breadth l of the columnar oxide particles 12 are defined as described above, l≦L.

The relational expression of the particle size R of the magnetic metal particles 10 and the length L of the columnar oxide particles 12 is 0.002≦L/R≦0.4. With this relational expression, increases in intraparticle eddy-current loss due to aggregation of the magnetic metal particles 10 can be effectively restrained with a small amount of oxide particles, and the contact area between the surface of one magnetic metal particle 10 and one columnar oxide particle 12 becomes larger, so that the two kinds of particles are firmly integrated with each other. As the amount of the oxide particles is small, the magnetic material characteristically has high saturation magnetization and high magnetic permeability. Also, as the columnar oxide particles 12 firmly adhere to the magnetic metal particles 10, the columnar oxide particles 12 are not easily detached from the magnetic metal particles 10 during the magnetic material manufacturing process, and variations in the product characteristics can be made smaller. If L/R is smaller than 0.002, a large number of oxide particles are required to sufficiently restrain aggregation of the magnetic metal particles 10, and as a result, uniform oxide particle dispersion on the surfaces of the magnetic metal particles 10 becomes difficult, which is not preferable. If L/R is larger than 0.4, unnecessary spaces appear in the vicinities of the interfaces where the magnetic metal particles 10 are in contact with the columnar oxide particles 12. As a result, saturation magnetization and magnetic permeability might become lower, and the columnar oxide particles 12 might be detached from the magnetic metal particles 10 during the manufacturing process.

The mean particle size of the magnetic metal particles 10 is preferably not smaller than 100 nm and not larger than 20 μm. In general, eddy-current loss is proportional to the square of frequency, and increases in high-frequency bands. If the particle size of the magnetic metal particles 10 is larger than 20 μm, the eddy-current loss that occurs in the particles becomes conspicuous at about 1 MHz or higher than 1 MHz, which is not preferable. Also, the ferromagnetic resonance frequency becomes lower, and loss due to ferromagnetic resonance occurs in MHz bands, which is not preferable, either. If the particle size of the magnetic metal particles 10 is smaller than 100 nm, the eddy-current loss in MHz bands is small, but the coercive force is large, and hysteresis loss increases, which is not preferable. As described above, to realize a magnetic material that has low magnetic loss in MHz bands, the particle size of the magnetic metal particles 10 needs to fall within a suitable range. In a case where the particle size of the magnetic metal particles 10 is equal to or smaller than 20 μm, however, aggregation of the magnetic metal particles 10 tends to progress quickly, and the eddy-current loss increases. In this embodiment, the columnar oxide particles 12 are made to adhere to the surfaces of the magnetic metal particles 10, so even the magnetic metal particles 10 of 20 μm or smaller in particle size can restrain from aggregation, and achieve excellent characteristics in high-frequency bands such as MHz and higher bands. So as to restrain aggregation and obtain characteristics that excel in high-frequency bands such as MHz and higher bands, a more preferable range of particle sizes for the magnetic metal particles 10 is 1 μm≦R≦10 μm.

The ratio (aspect ratio) between the length L and the breadth l of the columnar oxide particles 12 is preferably expressed as 2≦L/l≦50. If the aspect ratio is lower than 2, the above described effects of the oxide particles being in columnar form might not be easily achieved. If the aspect ratio is higher than 50, unnecessary spaces appear in the vicinities of the interfaces where the magnetic metal particles 10 are in contact with the columnar oxide particles 12. As a result, saturation magnetization and magnetic permeability might become lower, and the columnar oxide particles 12 might be detached from the magnetic metal particles 10 during the manufacturing process.

The proportion of the cross-sectional areas of each of the plurality of the columnar oxide particles 12 to the cross-sectional areas of each of the plurality of the magnetic metal particles 10 is preferably not lower than 0.1% and not higher than 20%. If the proportion of the cross-sectional areas of the columnar oxide particles 12 to the cross-sectional areas of the magnetic metal particles 10 is lower than 0.1%, aggregation of the magnetic metal particles 10 might not be effectively restrained. If the proportion of the cross-sectional areas of the columnar oxide particles 12 to the cross-sectional areas of the magnetic metal particles 10 is higher than 20%, the filling rate of the magnetic metal particles 10 becomes lower, and saturation magnetization and magnetic permeability might decrease.

The proportion of the cross-sectional areas of the columnar oxide particles 12 to the cross-sectional areas of the magnetic metal particles 10 is calculated by observing cross-sections of particles with a TEM or the like, for example. A cross-sectional image of the magnetic material is observed at such a minimum magnification that exactly ten magnetic metal particles 10 are included in a cross-sectional TEM image, where the ten magnetic particles 10 are in contact with columnar oxide particles 12 and are not aggregated with the other magnetic metal particles 10. From this image, the magnetic metal particle 10 with the largest size is selected, and the magnetic metal particle 10 with the largest size is enlarged to fit in the field of view. The boundaries between the selected magnetic metal particle 10 and the columnar oxide particles 12 are determined from the field of view accommodating the single magnetic metal particle 10, and the cross-sectional area proportion can be calculated through image processing. Here, the cross-sectional areas of the columnar oxide particles 12 are the cross-sectional areas of the primary particles in direct contact with the surface of the selected magnetic metal particle 10. In a case where no columnar oxide particles 12 are in contact with the magnetic metal particle 10 with the largest size, for example, the magnetic metal particle 10 with the second largest size, the magnetic metal particle 10 with the third largest size, and the rest of the magnetic metal particles are sequentially selected, and the proportion is calculated.

So as to cause the columnar oxide particles 12 to adhere to or be in contact with the surfaces of the magnetic metal particles 10 when the magnetic material of this embodiment is manufactured, the magnetic metal particles 10 and the columnar oxide particles 12 are preferably mixed with a mill, and are then subjected to thermal treatment. Through the mixing with a mill, the magnetic metal particles 10 and the columnar oxide particles 12 can be uniformly mixed. As the thermal treatment is performed after the mixing, mutual thermal diffusion occurs between the Fe, Co, or Ni atoms in the magnetic metal particles 10 and the Al, Si, or Ti atoms in the columnar oxide particles 12 at the interfaces between the magnetic metal particles 10 and the columnar oxide particles 12, and the columnar oxide particles 12 are firmly integrated with the magnetic metal particles 10. The mill used here may be a tumbling ball mill, a vibrating ball mill, or a stirring ball mill, for example. The mill used in the processing may be a wet mill that uses a solvent, or a dry mill that does not use a solvent. The thermal treatment after the mixing of the magnetic metal particles 10 and the columnar oxide particles 12 is preferably performed in a reductive atmosphere. By performing the thermal treatment in a reductive atmosphere, the columnar oxide particles 12 can be firmly integrated with the magnetic metal particles 10, while decreases in saturation magnetization due to oxidation of the magnetic metal particles 10 are restrained. When the thermal treatment is performed in a reductive atmosphere, the natural oxide films existing on the surfaces of the magnetic metal particles 10 are first reduced to magnetic metal. At the interfaces between the reduced surfaces of the magnetic metal particles 10 and the columnar oxide particles 12, mutual thermal diffusion occurs between the Fe, Co, or Ni atoms and the Al, Si, or Ti atoms, and the columnar oxide particles 12 adhere to the surfaces of the magnetic metal particles 10. When the magnetic material is pulled back to the air after the thermal treatment, natural oxide films are again formed in the portions of the surfaces of the magnetic metal particles 10 not in contact with the columnar oxide particles 12. Alternatively, by replacing the reductive atmosphere with an oxidizing atmosphere such as an oxygen gas after the thermal treatment, oxide films 18 can be formed in the portions of the surfaces of the magnetic metal particles 10 not in contact with the columnar oxide particles 12. Here, the reductive atmosphere is preferably a hydrogen gas, a mixed gas of hydrogen and nitrogen, or a mixed gas of hydrogen and argon (such as a mixed gas including a hydrogen gas at a density of 5%, for example).

Compositional analysis of the elements used in this embodiment can be carried out by a method using TEM-EDX (Energy Dispersive X-ray Fluorescence Spectrometer), for example.

### Second Embodiment

A magnetic material according to this embodiment includes: a plurality of magnetic metal particles, each of the plurality of the magnetic metal particles including a magnetic metal portion including at least one element selected from a first group consisting of Fe, Co, and Ni, and an oxide film including at least one element selected from the first group and included in the magnetic metal portion, the oxide film covering part of the magnetic metal portion; a plurality of columnar oxide particles, each of the plurality of the columnar oxide particles including at least one oxide selected from a second group consisting of Al₂O₃, SiO₂, and TiO₂, each of the columnar oxide particles being in contact with the magnetic metal portion; and a matrix phase having a higher electrical resistance than each of the plurality of the magnetic metal particles, the matrix phase surrounding the plurality of magnetic metal particles and the plurality of columnar oxide particles, wherein 5 nm≦l≦L, and 0.002≦L/R≦0.4, where R represents a particle size of the magnetic metal particle, L represents a length of the columnar oxide particle, and l represents a breadth of the columnar oxide particle.

In the description of this embodiment, explanation of some of the same aspects as those of the first embodiment will not be repeated.

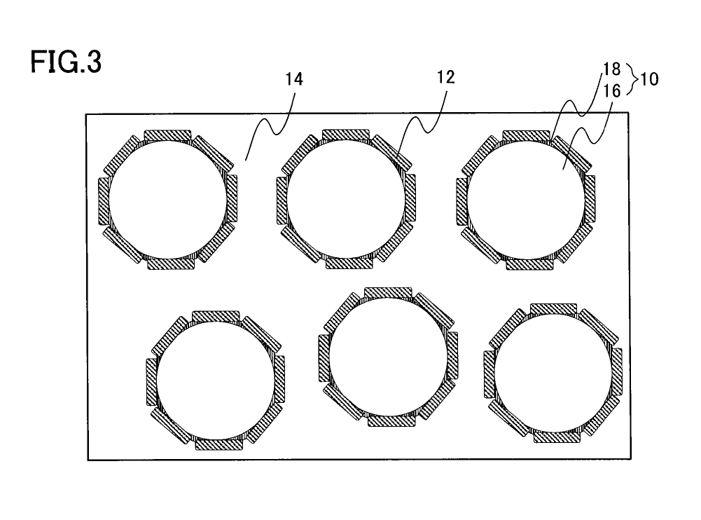

FIG. 3 is a schematic cross-sectional view of the magnetic material of this embodiment. The magnetic material of this embodiment includes magnetic metal portions 16, oxide films 18 covering part of each corresponding magnetic metal portion 16, magnetic metal particles 10 including the magnetic metal portions 16 and the oxide films 18, columnar oxide particles 12, and a matrix phase 14. The columnar oxide particles 12 preferably include none of the elements included in the first group consisting of Fe, Co, and Ni, at least one of which is included in the magnetic metal particles 10.

There are cases where the oxide films 18 such as natural oxide films are naturally formed on the surfaces of the magnetic metal particles 10. Where the columnar oxide particles 12 are in contact with the magnetic metal particles 10 via the oxide films 18, the columnar oxide particles 12 are not sufficiently integrated with the magnetic metal particles 10.

In this embodiment, the columnar oxide particles 12 are in direct contact with the magnetic metal portions 16, not with the oxide films 18. With this arrangement, the columnar oxide particles 12 can be firmly integrated with the magnetic metal particles 10. To achieve the integration, thermal treatment is preferably performed in a reductive atmosphere when the columnar oxide particles 12 are made to adhere or be in contact with the surfaces of the magnetic metal particles 10. When the thermal treatment is performed in a reductive atmosphere, the natural oxide films existing on the surfaces of the magnetic metal particles 10 are reduced to magnetic metal, and the magnetic metal portions 16 are exposed over the surfaces of the magnetic metal particles 10. At the interfaces between the magnetic metal portions 16 and the columnar oxide particles 12, mutual thermal diffusion occurs between the Fe, Co, or Ni atoms and the Al, Si, or Ti atoms, and the columnar oxide particles 12 adhere to the magnetic metal portions 16. When the magnetic material is pulled back to the air after the thermal treatment, natural oxide films are again formed in the portions of the surfaces of the magnetic metal particles 10 not in contact with the columnar oxide particles 12. Alternatively, by replacing the reductive atmosphere with an oxidizing atmosphere such as an oxygen gas after the thermal treatment, the oxide films 18 can be formed in the portions of the surfaces of the magnetic metal particles 10 not in contact with the columnar oxide particles 12. Here, the reductive atmosphere is preferably a hydrogen gas, a mixed gas of hydrogen and nitrogen, or a mixed gas of hydrogen and argon (such as a mixed gas including a hydrogen gas at a density of 5%, for example).

### Third Embodiment

A device of this embodiment is a device that includes one of the magnetic materials described in the above embodiments. Therefore, explanation of the same aspects as those of the above embodiments will not be repeated herein.

The device of this embodiment is a high-frequency magnetic component such as an inductor, a choke coil, a filter, or a transformer, an antenna substrate or component, or a radiowave absorber, for example.

It is an inductor that can make the most of the features of the magnetic materials of the above described embodiments. Particularly, when the above described embodiments are applied to a power inductor to which a high current is applied in MHz bands such 1 MHz and higher bands, the characteristics of the magnetic materials, such as high saturation magnetization, high magnetic permeability, and low magnetic loss, can be easily utilized.

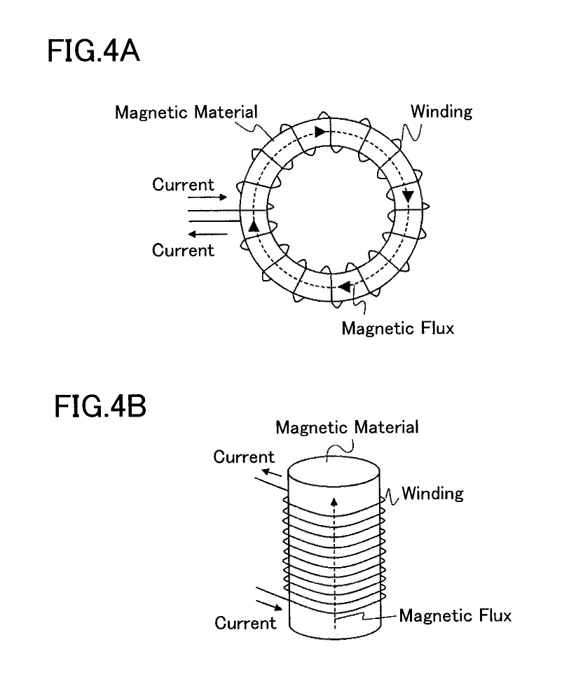

FIGS. 4A and 4B, FIGS. 5A and 5B, and FIG. 6 are conceptual diagrams showing examples of inductors of this embodiment.

The most basic examples include a form in which a coil winding is attached to a ring-like magnetic material as shown in FIG. 4A, and a form in which a coil winding is attached to a rod-like magnetic material as shown in FIG. 4B. To integrate the matrix phase 14 with the magnetic metal particles 10 in a ring-like or rod-like form, press molding is preferably performed at a pressure of 0.1 kgf/cm² or higher. If the pressure is lower than 0.1 kgf/cm², more voids are formed in the molded material, and the volume fraction of the magnetic metal particles 10 becomes lower, resulting in lower saturation magnetization and magnetic permeability. The press molding may be performed by a uniaxial press molding method, a hot press molding method, a CIP (cold isostatic press) method, an HIP (hot isostatic press) method, an SPS (spark plasma sintering) method, or the like.

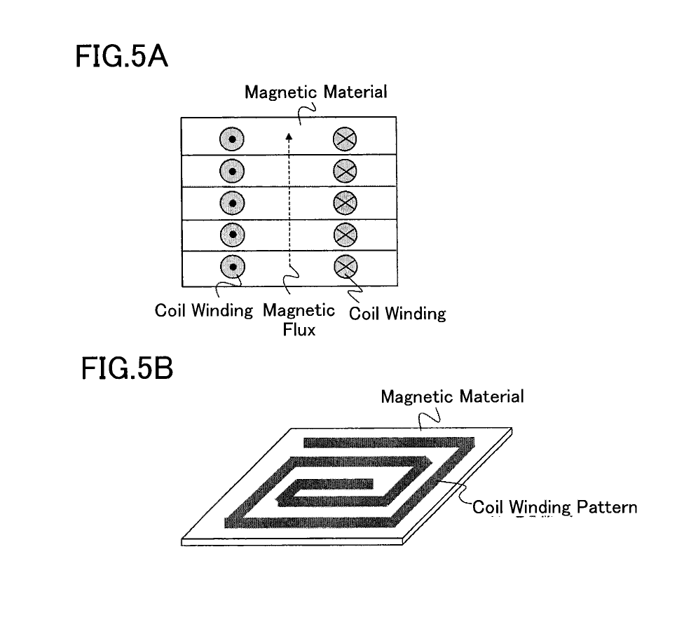

Further, it is possible to form a chip inductor in which a coil winding is integrated with a magnetic material as shown in FIG. 5A, and a plane-type inductor or the like as shown in FIG. 5B. The chip inductor may be of a stack type as shown in FIG. 5A.

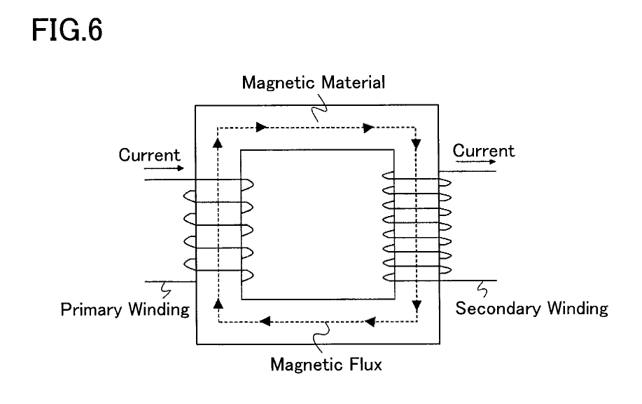

FIG. 6 shows an inductor having a transformer structure.

FIGS. 4A through 6 merely show typical example structures, and in practice, it is preferable to change the structures and the sizes in accordance with purposes of use and required inductor characteristics.

With the device of this embodiment, it is possible to realize a device that has excellent characteristics such as high magnetic permeability and low magnetic loss in MHz bands, particularly in 1 MHz and higher bands.

### EXAMPLES

The following is a description of Examples of the embodiments.

### Example 1

Fe particles of 5 μm in particle size R, and columnar Al₂O₃ particles being in cylindrical form of 40 nm in length L and 10 nm in breadth l were placed into a tumbling ball mill using a stainless container and stainless balls at a weight ratio of 100:2.5. The Fe particles and the columnar Al₂O₃ particles were mixed in an Ar atmosphere at 60 rpm for two hours. Further, 30-minute thermal treatment was performed in a hydrogen atmosphere at 500 degrees C., to obtain Fe particles having the columnar Al₂O₃ particles adhering to the surfaces thereof. When the Fe particles were observed with a transmission electron microscope (TEM) at 100,000 magnifications, L/R was 0.008, and L/l was 4. When the proportion of the areas of the columnar oxide particles 12 to the areas of the magnetic metal particles 10 was calculated in a TEM image observed at 25,000 magnifications, the proportion was 0.20. The particles subjected to the thermal treatment and a vinyl resin were mixed at a weight ratio of 100:2.5, to form a ring-like evaluation material through press molding.

When the intensity of magnetization with respect to an applied magnetic field to the evaluation material was measured with a vibrating sample magnetometer (VSM), the saturation magnetization was 1.45 T.

A copper wire was wound around this evaluation material 40 times, and the relative permeability and the magnetic loss (core loss) at 1 MHz were measured with B-H Analyzer SY-8232 (manufactured by Iwatsu Test Instruments Corporation). When magnetic loss is measured, magnetic flux density conditions need to be determined in accordance with the magnetic permeability of each material. Where B represents magnetic flux density, μ represents magnetic permeability, L represents inductance, I represents current, and V represents volume, B²=μLI²/V. In this embodiment, the magnetic flux density conditions of the respective materials were determined so that B=9.38 mT when L, I, and V were constant, and μ=10 (for example, B=6.63 mT when μ=5). The evaluation material formed in the above described manner was 19.7 in relative permeability, and 0.22 W/cc in magnetic loss. The results of the above are shown in Table 1.

### Example 2

An evaluation material was formed and measured in the same manner as in Example 1, except that columnar Al₂O₃ particles being in cylindrical form of 10 nm in length L and 5 nm in breadth l were used. The results are shown in Table 1.

### Example 3

An evaluation material was formed and measured in the same manner as in Example 1, except that columnar Al₂O₃ particles being in cylindrical form of 2 μm in length L and 100 nm in breadth l were used. The results are shown in Table 1.

### Example 4

An evaluation material was formed and measured in the same manner as in Example 1, except that Fe particles of 20 μm in particle size R were used. The results are shown in Table 1.

### Example 5

An evaluation material was formed and measured in the same manner as in Example 1, except that Fe particles of 100 nm in particle size R were used. The results are shown in Table 1.

### Comparative Example 1

An evaluation material was formed and measured in the same manner as in Example 1, except that Fe particles of 20 μm in particle size R were used. The results are shown in Table 1.

### Comparative Example 2

An evaluation material was formed and measured in the same manner as in Example 1, except that columnar Al₂O₃ particles being in cylindrical form of 2.2 μm in length L and 200 nm in breadth l were used. The results are shown in Table 1.

### Example 6

An evaluation material was formed and measured in the same manner as in Example 1, except that Fe particles of 50 nm in particle size R and columnar Al₂O₃ particles being in cylindrical form of 20 nm in length L and 10 nm in breadth l were used. The results are shown in Table 1.

### Example 7

An evaluation material was formed and measured in the same manner as in Example 1, except that Fe particles of 25 μm in particle size R and columnar Al₂O₃ particles being in cylindrical form of 2 μm in length L and 100 nm in breadth l were used. The results are shown in Table 1.

### Example 8

An evaluation material was formed and measured in the same manner as in Example 1, except that columnar Al₂O₃ particles being in cylindrical form of 500 nm in length L and 10 nm in breadth l were used. The results are shown in Table 1.

### Example 9

An evaluation material was formed and measured in the same manner as in Example 1, except that columnar Al₂O₃ particles being in cylindrical form of 40 nm in length L and 25 nm in breadth l were used. The results are shown in Table 1.

### Example 10

An evaluation material was formed and measured in the same manner as in Example 1, except that columnar Al₂O₃ particles being in cylindrical form of 600 nm in length L and 10 nm in breadth l were used. The results are shown in Table 1.

### Example 11

An evaluation material was formed and measured in the same manner as in Example 1, except that Fe particles of 100 nm in particle size R were used, and the Fe particles and the columnar Al₂O₃ particles were mixed at a weight ratio of 100:25. The results are shown in Table 1.

### Example 12

An evaluation material was formed and measured in the same manner as in Example 1, except that the Fe particles and the columnar Al₂O₃ particles were mixed at a weight ratio of 100:0.2. The results are shown in Table 1.

### Example 13

An evaluation material was formed and measured in the same manner as in Example 1, except that Fe particles of 100 nm in particle size R were used, and the Fe particles and the columnar Al₂O₃ particles were mixed at a weight ratio of 100:30. The results are shown in Table 1.

### Example 14

An evaluation material was formed and measured in the same manner as in Example 1, except that Co particles were used instead of the Fe particles. The results are shown in Table 1.

### Example 15

An evaluation material was formed and measured in the same manner as in Example 1, except that Ni particles were used instead of the Fe particles. The results are shown in Table 1.

### Example 16

An evaluation material was formed and measured in the same manner as in Example 1, except that SiO₂ was used instead of Al₂O₃. The results are shown in Table 1.

### Example 17

An evaluation material was formed and measured in the same manner as in Example 1, except that TiO₂ was used instead of Al₂O₃. The results are shown in Table 1.

### Example 18

An evaluation material was formed and measured in the same manner as in Example 1, except that an epoxy resin was used instead of the vinyl resin. The results are shown in Table 1.

TABLE 1

| | | | | | | | Saturation | | Magnetic |
|---|---|---|---|---|---|---|---|---|---|
| | R | L | l | | | area | Magnetization | Relative | loss |
| | [μm] | [nm] | [nm] | L/R | L/l | [%] | [T] | permeability | [W/cc] |
| Example 1 | 5 | 40 | 10 | 0.008 | 4 | 0.2 | 1.45 | 19.7 | 0.22 |
| Example 2 | 5 | 10 | 5 | 0.002 | 2 | 0.1 | 1.46 | 19.8 | 0.23 |
| Example 3 | 5 | 2000 | 100 | 0.4 | 20 | 3.0 | 1.40 | 16.0 | 0.23 |
| Example 4 | 20 | 40 | 10 | 0.002 | 4 | 0.1 | 1.47 | 21.0 | 0.41 |
| Example 5 | 0.1 | 40 | 10 | 0.4 | 4 | 2.9 | 1.37 | 15.4 | 0.42 |
| Comparative | 20 | 30 | 10 | 0.0015 | 3 | 0.1 | 1.47 | 20.5 | 0.55 |
| Example 1 | | | | | | | | | |
| Comparative | 5 | 2200 | 200 | 0.44 | 11 | 3.1 | 1.29 | 13.0 | 0.22 |
| Example 2 | | | | | | | | | |
| Example 6 | 0.05 | 20 | 10 | 0.4 | 2 | 3.0 | 1.37 | 15.2 | 0.45 |
| Example 7 | 25 | 2000 | 100 | 0.08 | 20 | 1.0 | 1.39 | 15.5 | 0.46 |
| Example 8 | 5 | 500 | 10 | 0.1 | 50 | 0.2 | 1.41 | 16.2 | 0.23 |
| Example 9 | 5 | 40 | 25 | 0.008 | 1.6 | 0.9 | 1.45 | 19.6 | 0.46 |
| Example 10 | 5 | 600 | 10 | 0.12 | 60 | 0.3 | 1.39 | 15.6 | 0.25 |
| Example 11 | 0.1 | 40 | 10 | 0.4 | 4 | 20 | 1.37 | 15.3 | 0.42 |
| Example 12 | 5 | 40 | 10 | 0.008 | 4 | 0.08 | 1.47 | 20.1 | 0.47 |
| Example 13 | 0.1 | 40 | 10 | 0.4 | 4 | 25 | 1.34 | 15.1 | 0.46 |
| Example 14 | 5 | 40 | 10 | 0.008 | 4 | 0.2 | 1.21 | 16.0 | 0.23 |
| Example 15 | 5 | 40 | 10 | 0.008 | 4 | 0.2 | 0.52 | 16.2 | 0.22 |
| Example 16 | 5 | 40 | 10 | 0.008 | 4 | 0.2 | 1.45 | 19.7 | 0.22 |
| Example 17 | 5 | 40 | 10 | 0.008 | 4 | 0.2 | 1.45 | 19.7 | 0.22 |
| Example 18 | 5 | 40 | 10 | 0.008 | 4 | 0.2 | 1.45 | 19.7 | 0.22 |

In the magnetic materials of Examples 1 through 18, the columnar oxide particles 12 adhere to the surfaces of the magnetic metal particles 10, 5 nm≦l≦L, and 0.002≦L/R≦0.4 where R represents the particle size of the magnetic metal particles 10, L represents the length of the columnar oxide particles 12, and l represents the breadth of the columnar oxide particles 12. As is apparent from Table 1, each magnetic loss at 1 MHz of Examples 1 through 18 is smaller than the magnetic loss of Comparative Example 1, which does not satisfy the condition, 0.002≦L/R≦0.4. Also, each relative permeability of Examples is higher than the relative permeability of Comparative Example 2, which does not satisfy the condition, 0.002≦L/R≦0.4. As can be seen from the above, the magnetic materials of Examples have excellent magnetic characteristics, such as high magnetic permeability and low magnetic loss, in high-frequency bands.

In Examples 1 through 5, 8, 11, and 14 through 18 where 100 nm≦R≦20 μm, 2≦L/l≦50, and the proportion of the areas of the columnar oxide particles 12 to the areas of the magnetic metal particles 10 in a cross-section of the magnetic metal particles 10 is not lower than 0.1% and not higher than 20%, each magnetic loss at 1 MHz is lower or each relative permeability is higher than in Examples 6, 7, 9, 10, 12, and 13, which do not satisfy the above conditions, and the magnetic characteristics in high-frequency bands are excellent.

Particularly, Examples 1, 2, and 16 through 18 have excellent magnetic characteristics, such as high saturation magnetization, high magnetic permeability, and low magnetic loss, in high-frequency bands.

While certain embodiments have been described, these embodiments have been presented by way of example only, and are not intended to limit the scope of the inventions. Indeed, a magnetic material and a device described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. A magnetic material comprising:
a plurality of magnetic metal particles, each of the plurality of the magnetic metal particles including at least one element selected from a first group consisting of Fe, Co, and Ni;
a plurality of columnar oxide particles, each of the plurality of the columnar oxide particles including at least one oxide selected from a second group consisting of Al₂O₃, SiO₂, and TiO₂, each of the plurality of the columnar oxide particles being in contact with the magnetic metal particle; and
a matrix phase having a higher electrical resistance than each of the plurality of the magnetic metal particles, the matrix phase surrounding the plurality of magnetic metal particles and the plurality of columnar oxide particles,
wherein
5 nm≦l≦L, and
0.002≦L/R≦0.4,
where R represents a particle size of the magnetic metal particle, L represents a length of the columnar oxide particle, and l represents a breadth of the columnar oxide particle.

2. The magnetic material according to claim 1, wherein 100 nm≦R≦20 μm.

3. The magnetic material according to claim 1, wherein 2≦L/l≦50.

4. The magnetic material according to claim 1, wherein a proportion of a cross-sectional area of each of the plurality of the columnar oxide particles to a cross-sectional area of each of the plurality of the magnetic metal particles is not lower than 0.1% and not higher than 20%.

5. A magnetic material comprising:
a plurality of magnetic metal particles, each of the plurality of the magnetic metal particles including a magnetic metal portion including at least one element selected from a first group consisting of Fe, Co, and Ni, and an oxide film including at least one element selected from the first group and included in the magnetic metal portion, the oxide film covering part of the magnetic metal portion;
a plurality of columnar oxide particles, each of the plurality of the columnar oxide particles including at least one oxide selected from a second group consisting of Al₂O₃, SiO₂, and TiO₂, each of the columnar oxide particles being in contact with the magnetic metal portion; and
a matrix phase having a higher electrical resistance than each of the plurality of the magnetic metal particles, the matrix phase surrounding the plurality of magnetic metal particles and the plurality of columnar oxide particles,
wherein
5 nm≦l≦L, and
0.002≦L/R≦0.4,
where R represents a particle size of the magnetic metal particle, L represents a length of the columnar oxide particle, and l represents a breadth of the columnar oxide particle.

6. The magnetic material according to claim 5, wherein 100 nm≦R≦20 μm.

7. The magnetic material according to claim 5, wherein 2≦L/l≦50.

8. The magnetic material according to claim 5, wherein a proportion of a cross-sectional area of each of the plurality of the columnar oxide particles to a cross-sectional area of each of the plurality of the magnetic metal particles is not lower than 0.1% and not higher than 20%.

9. A device using the magnetic material of claim 1.
